(19) United States
(12) Patent Application Publication
(10) Pub. No.: US 2009/0031700 A1
(43) Pub. Date: Feb. 5, 2009

(54) Mixtures of oxides of nitrogen and oxygen as oxidizers for propulsion, gas generation and power generation applications

(75) Inventor: Arif Karabeyoglu, Portola Valley, CA (US)

Correspondence Address: WILSON SONSINI GOODRICH & ROSATI, 650 PAGE MILL ROAD, PALO ALTO, CA, 94304-1050, US

(73) Assignee: Space Propulsion Group, Inc., Sunnyvale, CA (US)

(21) Appl. No.: 11/985,041

(22) Filed: Nov. 12, 2007

Related U.S. Application Data
(60) Provisional application No. 60/858,443, filed on Nov. 13, 2006.

(51) Int. Cl. C06B 47/04; F02K 9/00

(52) U.S. Cl. 60/205; 149/74

(57) ABSTRACT

This invention involves the mixtures of oxides of nitrogen and oxygen (O₂) as the oxidizing component in propulsion, gas generation and power generation applications. Advantages of the oxidizers of the inventions may be self pressurization, high density, density impulse, higher operational temperatures, and high Isp performance. The invention provides devices, methods and compositions related to the disclosed oxidizers.

### CROSS-REFERENCE

This application claims the benefit of U.S. Provisional Application No. 60/858,443, filed Nov. 13, 2006, which application is incorporated herein by reference.

### BACKGROUND OF THE INVENTION

The list of potential oxidizers currently available to be used in chemical propulsion and power generation systems is quite limited. Some of the chemical oxidizers used for these systems are described and referred to, for example, in U.S. Pat. Nos. 2,983,099 and 6,378,291. The liquid oxidizers commonly used in rocket and power generation applications include oxygen (O₂), dinitrogen tetroxide (N₂O₄), hydrogen peroxide (H₂O₂), nitrous oxide (N₂O), mixtures of nitrogen oxides (MON), hydroxyl amine nitrate (HAN), red fuming nitric acid and white fuming nitric acid. More exotic liquid oxidizers which are rarely used due to their extreme toxicity or high shock/thermal sensitivity include halogens such as fluorine (F₂), chlorine (Cl₂), interhalogen compounds such as chlorine trifluorine (ClF₃), FLOX (mixtures of fluorine and oxygen), ozone (O₃), oxygen bifluorine (OF₂), and nitrogen trifluorine (NF₃). Commonly used solid oxidizers include ammonium perchlorate (NH₄ClO₄), ammonium nitrate (NH₄NO₃) and potassium perchlorate (KClO₄).

Each oxidizer on this list has significant shortcomings. For example, the commonly used high performance oxidizer liquid oxygen is a cryogenic material with a normal boiling temperature of 90° K. The high density storable oxidizer H₂O₂ has significant safety issues due to its tendency to self decompose (and potentially detonate). Solid phase oxidizers used in solid rocket applications generally suffer from low Isp performance, and widely used perchlorate based solid oxidizers raise significant environmental concerns.

Two known liquid oxidizers in their respective fields of applications are liquid oxygen (O₂, commonly referred to as “LOX”) and nitrous oxide (N₂O). Liquid oxygen is a high performance oxidizer which is commonly used in liquid and hybrid rockets with substantial total impulse requirements. N₂O has generally been the choice for relatively small rocket systems due to its self pressurizing capability arising from its high vapor pressure at room temperature. Self pressurization can be useful because it eliminates the additional weight, complexity and cost of the pressurization system (i.e. such as He gas pressurization commonly used with liquid oxygen based systems) or the turbopump system needed to feed a liquid oxidizer into the combustion chamber at high pressures. The common features for both of these oxidizers is their low toxicity, environmental friendliness and cost effectiveness compared to the other chemicals used as oxidizing agents in propulsion and power generation systems.

In the following paragraphs, the advantages and disadvantages of liquid oxygen and nitrous oxide systems as they relate to the design of cost effective and reliable propulsion and power generation systems are summarized.

LOX has several disadvantages. First, it is a deep cryogenic material with a boiling temperature of 90° K, which introduces significant operational difficulties and inconveniencies. The low operational temperature has an adverse effect on the mass fraction of the propulsion system due to the requirement for a tank insulation layer to minimize boil-off and also because of a limit on the range of materials that can be used as tank materials (such as the absence of LOX capable composite tank technology). Second, motor stability and efficiency can be difficult to obtain with LOX. In the case of hybrid systems, stable and efficient operation is typically achieved by adding a heating source at or around the injection point of the LOX. This undesirable fix may complicate the design and may increases the cost and weight of the overall propulsion system. For liquid rocket systems, it is well known that LOX engines running with hydrocarbons such as RP1 tend to produce rough combustion. These systems typically require a significant amount of development effort until the desired stability margin is attained. Third, LOX is rarely used as a self pressurizing oxidizer since its density is very low at operationally desirable pressures (see FIGS. 1 and 4). For example, at 50 atm pressure, density of LOX is only 550 kg/m³ compared to its density of 1,140 kg/m³ at atmospheric pressure. Moreover, LOX presents a very strong dependency between density and pressure along the saturation line as shown in FIG. 4. Furthermore, oxygen cleaning of the feed system components is critical, as LOX fires are common due to reactions with impurities.

On the other hand, LOX has several advantages including high Isp performance, high chemical stability of diatomic oxygen, a wide experience base, and low cost. Additionally, LOX allows a system to optimize at a relatively low oxidizer to fuel ratio reducing the fraction of liquids in the case of a hybrid system.

N₂O has several disadvantages, including modest Isp performance, and low density (when self pressurization is needed). At low temperatures the density can be improved but the vapor pressure drops significantly (see FIGS. 1 and 4). Correspondingly, N₂O has a low impulse density (impulse density is the thrust force generated per unit volume of propellant expelled in unit time). It also has a high dependency of density and pressure on the temperature. Temperature conditioning is required for most practical applications. The nitrous oxide molecule has a positive heat of formation, so that uncontrolled self decomposition in the tank, feed lines and the combustion chamber is possible, and might result in catastrophic failure. Finally, use of N₂O leads to an optimal system at a high oxidizer to fuel ratio, requiring a high mass fraction of liquids (for hybrid rockets).

However, N₂O has several advantages, including self pressurization capability due to its high vapor pressure at room temperature. Also with N₂O, stable and efficient combustion is much easier to attain due to the exothermic decomposition reaction of the oxidizer molecule. There is an extensive experience base in the hybrid propulsion area (at least at small scales). Finally, it is an accessible and fairly inexpensive chemical commonly used in several industries.

A new group of oxidizers which are eutectic mixtures of inorganic nitrate oxidizers has been disclosed by Bruenner et al. (U.S. Pat. No. 5,837,931). These oxidizers present a high explosion/fire hazard and appear to be inferior in Isp performance.

Based on these shortcomings, it is clear that development of new improved oxidizers would constitute a critical technological enhancement in the field of chemical propulsion, gas generation and power generation. Desirable attributes for the oxidizing component of the propellant system include the following: high specific impulse (Isp) performance with common fuels, high density, good combustion stability and efficiency characteristics, chemically stable, nontoxic, storable under normal conditions, adequate self pressurization for pressure fed systems (or low vapor pressure for pump fed systems), low freezing point, hypergolic behavior with common fuels, ease of handling, low cost, environmental aspects (“green propellants”) and compatibility with tank and feed system materials.

### SUMMARY OF THE INVENTION

The present invention provides compositions, devices and methods relating to oxidizers comprising mixtures of oxygen and oxides of nitrogen for use in various propulsion, power production and gas generation applications. In one embodiment, the invention provides a composition of matter comprising a mixture of oxygen, an oxide of nitrogen and a fuel. The oxide of nitrogen can be a compound chosen from the group consisting of nitrous oxide, nitric oxide, nitrogen dioxide and dinitrogen tetroxide or a mixture thereof. In specific embodiments, the oxide of nitrogen is nitrous oxide. In some cases, the mass fraction of oxygen in the mixtures of the invention can be about 0.15 (i.e., 15%). In other embodiments, the mass fraction of oxygen can range from 0.1 to 0.2, from 0.05 to 0.25, from 0.02 to 0.35 or from 0.02 to 0.50. The compositions of the invention can be in liquid or gaseous form, and may or may not be at thermodynamical equilibrium. At −60° C., the mixture will contain both liquid and vapor phases, with the ratio of oxygen to, e.g., nitrous oxide, being greater in the vapor phase due to its greater volatility. In one embodiment, the oxygen component of the propellant may be in substantially liquid form. The fuel component may be in gaseous, liquid or solid form. Additional components such as methane or ozone (O₃) can be included. Additionally, the invention provides for compositions comprising mixtures of oxygen, an oxide of nitrogen and a gelling agent. In one embodiment, the gelling agent is silicon dioxide. The invention also discloses compositions comprising a mixture of an oxide of nitrogen, oxygen and an inert gas. In one embodiment, the inert gas is He. Alternatively, the inert gas can be helium, neon, xenon, krypton, radon or N₂. This invention also provides a composition comprising a mixture of oxygen, an oxide of nitrogen, and a compound in a mass fraction of at least 0.1% wherein the compound is selected from NO, O₃ or a fuel, e.g., pentane.

In one aspect this invention provide a device comprising a container containing a mixture of oxygen and an oxide of nitrogen, wherein the mixture has a temperature of no greater than −60° C. In certain embodiments, the mixture has a temperature no greater than −70° C., no greater than −80° C. or no greater than −90° C. In another embodiment, the mixture has a temperature between −60° C. and −90° C. In certain embodiment, the mixture is held at any of these temperatures for at least 8 hours. In other embodiments the mixture further comprises a fuel or a gelling agent.

A device of the invention can comprise (a) a first container comprising an oxidizer comprising an oxide of nitrogen and oxygen; (b) a second container comprising a fuel; (c) a combustion chamber in fluid or gaseous connection with the first container and/or with the second container, wherein the combustion chamber allows the combustion of a propellant comprising a mixture of the oxidizer and the fuel to produce combustion gases; and (d) an outlet allowing the release of combustion gases. The oxidizer can be substantially in liquid or gaseous form and may or may not be at thermodynamic equilibrium. In one embodiment, the oxidizer can be stored in a first container which is a composite storage tank. In another embodiment, the oxidizer can be stored in a first container which is a metal storage tank. The oxide of nitrogen can be a compound chosen from the group consisting of nitrous oxide, nitric oxide, nitrogen dioxide and dinitrogen tetroxide or a mixture thereof. In some embodiments, the outlet comprises a nozzle. In related embodiments, the device is a rocket device. The device can additionally comprise (a) an air inlet; (b) an air compressor; and (c) a gas turbine connected with the compressor. The device can be a jet engine. Alternatively, the device can be a gas generator. Further, the device can be a gas turbine. Further, the device can be an internal combustion engine. A device of the invention can be substantially self-pressurized. In some embodiments, the first container comprises O₃. In other embodiments, the first container additionally comprises a gelling agent. In still other embodiments, the first container additionally comprises an inert gas.

The invention also discloses a device comprising (a) a first container comprising an oxide of nitrogen; (b) a second container comprising oxygen; (c) a third container comprising a fuel; (d) a combustion chamber in fluid or gaseous connection with any or all of the first, second or third containers, wherein the combustion chamber allows the combustion of a propellant comprising a mixture of the oxide of nitrogen, oxygen and fuel to produce combustion gases; and (d) an outlet allowing the release of combustion gases. The oxide of nitrogen can be substantially in liquid form. The oxygen can be substantially in liquid or gaseous form. The oxide of nitrogen can be a compound chosen from the group consisting of nitrous oxide, nitric oxide, nitrogen dioxide and dinitrogen tetroxide or a mixture thereof. The outlet can comprise a nozzle. In some embodiments, the device is a rocket device. The device can additionally comprise (a) an air inlet; (b) an air compressor; and (c) a gas turbine connected with the compressor. The device can be a jet engine. Alternatively, the device can be a gas generator. Further, the device can be a gas turbine. A device of the invention can be substantially self-pressurized. In some embodiments, the first container comprises O₃. In other embodiments, the first container additionally comprises a gelling agent. In still other embodiments, the first container additionally comprises an inert gas. The device can be substantially self-pressurized.

Also described in the invention are devices comprising: (a) a first container comprising an oxidizer comprising oxygen, wherein the pressure within the container is between about 5 and 200 atm, and wherein the temperature within the container is between −100° C. and 20° C., and further wherein the mass fraction of oxygen within the container is about 0.15, e.g., between about 0.02 and 0.5; (b) a second container comprising a fuel; (c) a chamber in fluid or gaseous connection with the first container and/or the second container, wherein the combustion chamber allows the combustion of a propellant comprising a mixture of the oxygen and fuel to produce combustion gases; and (d) an outlet allowing the release of combustion gases. In some embodiments, the pressure within the first container is between about 5 and 120 atm, the temperature within the container is between −80° C. and 10° C., and the mass fraction of oxygen within the container is about 0.15, e.g., between about 0.02 and 0.35. The mass fraction of oxygen within the container may alternatively range as discussed above. In one embodiment, the mass fraction of oxygen is approximately 0.15. The devices can additionally comprise an oxide of nitrogen. The oxide of nitrogen can be a compound chosen from the group consisting of nitrous oxide, nitric oxide, nitrogen dioxide and dinitrogen tetroxide, or a mixture thereof. The outlet can comprise a nozzle. In some embodiments, the device is a rocket device. The device can additionally comprise (a) an air inlet; (b) an air compressor; and (c) a gas turbine connected with the compressor. The device can be a jet engine. Alternatively, the device can be a gas generator. Further, the device can be a gas turbine. A device of the invention can be substantially self-pressurized. In some embodiments, the first container comprises O₃. In other embodiments, the first container additionally comprises a gelling agent. In still other embodiments, the first container additionally comprises an inert gas.

Further disclosed herein are rocket devices comprising: a) components for a propellant wherein the components include (i) oxygen, (ii) an oxide of nitrogen and, optionally, (iii) a fuel; b) a combustion chamber comprising an outlet; c) means for feeding the components into the combustion chamber whereby the chamber comprises a propellant; and d) means to ignite the propellant in the combustion chamber, whereby propellant is combusted and expelled through the outlet. In one embodiment, such a device can be a liquid rocket wherein the device further comprises (i) a first container containing the oxidizer in liquid form; (ii) a second container containing the fuel; and (iii) means to mix the oxidizer and the fuel in the combustion chamber to form the propellant. In an alternative embodiment, the device can be a solid rocket wherein the motor further comprises a casing that contains the solid phase propellant and the combustion chamber is within the casing. In a further embodiment, the device can be a hybrid rocket wherein the motor further comprises a casing that contains the fuel: (i) a first container containing the oxidizer in liquid form; (ii) a casing comprising the fuel and the combustion chamber; and (iii) means for contacting the oxidizer with the fuel to produce the propellant. The outlet of the device can further comprise a nozzle. In another embodiment, the fuel comprises a solid oxidizer, e.g., a solid oxidizer selected from ammonium perchlorate, ammonium nitrate, potassium perchlorate and potassium nitrate.

The invention provides methods of operating a motor comprising a combustion chamber, the method comprising: (a) providing an oxidizer comprising an oxide of nitrogen and oxygen; (b) combusting the oxidizer in a combustion chamber to form a combustion gas; and (c) expelling the combustion gas from the motor. In some embodiments, the oxidizer is additionally contacted with a fuel. In related embodiments, the oxidizer is contacted with a fuel prior to combustion. The oxidizer can be provided in liquid or gaseous form. In specific embodiments, the oxidizer has a density greater than about 600 kg/m³, a temperature between about −100° C. and 20° C. and a pressure between about 0 and 200 atm. The fuel may be a solid, liquid or gas. In other embodiments, the oxidizer can have a density greater than about 800 kg/m³, a temperature between about −80° C. and 10° C. and a pressure between about 5 and 120 atm. Thrust can be generated during the step of expelling combustion gas.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

A fuller understanding of the nature and advantages of the mixtures of O₂ and N₂O will become apparent upon consideration of the following detailed description, taken in connection with the accompanying drawings, wherein:

FIG. 1 shows the saturated liquid density for oxygen and nitrous oxide as a function of temperature.

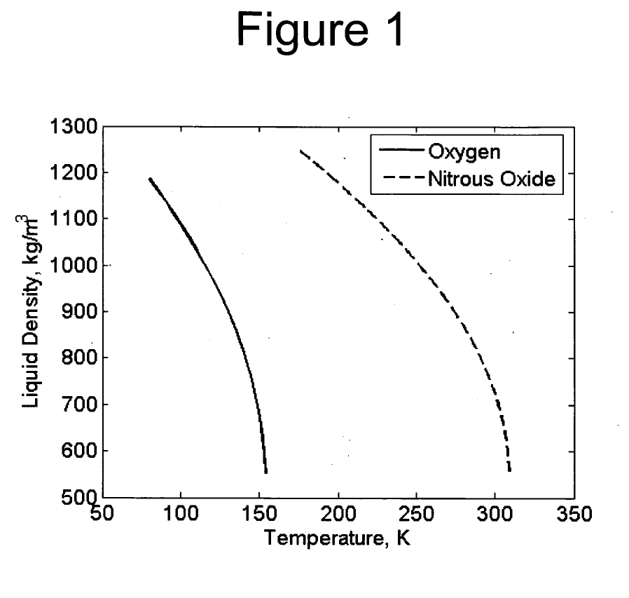

FIG. 2 shows experimental and theoretical data on the O₂/N₂O system at −30° C., where the mole fractions of oxygen in the liquid and vapor phases have been calculated using the Peng-Robinson equation of state and plotted along with the experimental phase equilibrium data (Zeinenger et al, 1972). The Peng-Robinson equation and the mixing rule used in the calculations have been described in the Appendix.

FIG. 3 shows the Peng-Robinson interaction parameter k₁₂ values obtained as a best fit to the experimental data as a function of temperature (See Appendix for the definition of the interaction parameter).

FIG. 4 shows the liquid densities estimated for the O₂/N₂O mixtures as a function pressure at different temperatures, with the liquid densities for pure substances (N₂O and O₂) included for reference.

FIG. 5 shows the mass fraction of the oxygen in the mixture as a function of pressure for various temperatures.

FIG. 6 shows the specific impulse performance of the O₂/N₂O mixtures at different oxygen concentrations, with the data for pure LOX, N₂O₄ and N₂O, included as reference.

FIG. 7 shows the characteristic velocity (c*) performance of the O₂/N₂O mixtures at different oxygen concentrations, with the data for pure LOX, N₂O₄ and N₂O, included as reference.

FIG. 8 shows the maximum Isp of the O₂/N₂O mixtures as a function of the oxygen mass fraction.

FIG. 9 shows the optimum oxidizer to fuel ratio (O/F) of the O₂/N₂O mixtures for maximum Isp, as a function of oxygen mass fraction.

FIG. 10 shows the maximum c* of the O₂/N₂O mixtures as a function of the oxygen mass fraction.

FIG. 11 shows the specific impulse of the O₂/N₂O mixtures as a function of pressure at various temperatures.

FIG. 12 shows the density impulse of the O₂/N₂O mixtures as a function of pressure at various temperatures.

FIG. 13 shows the density as a function of oxidizer temperature for O₂/N₂O mixtures operating at a pressure of 60 atm.

FIG. 14 shows the specific impulse as a function of oxidizer temperature for O₂/N₂O mixtures operating at a pressure of 60 atm.

FIG. 15 shows the impulse density as a function of oxidizer temperature for O₂/N₂O mixtures operating at a pressure of 60 atm.

FIG. 16 shows the normalized regression rate of a generic solid hydrocarbon fuel as a function of the mass fraction of oxygen in the O₂/N₂O mixture.

FIG. 17 compares the minimum ignition energy as a function of oxygen mass fraction in a N₂O/O₂ mixture for three pressure levels 34, 48 and 61 atm.

### DETAILED DESCRIPTION OF THE INVENTION

This invention relates to use of mixtures of an oxide of nitrogen and oxygen (“Nytrox”) as the oxidizing component of various propulsion, power and gas generating applications, such as rockets, turbojets, turbofans gas turbines, gas generators, internal combustion engines and combined cycle propulsion systems. In one specific embodiment, the invention is directed to the use of a liquid mixture of an oxide of nitrogen, such as nitrous oxide, and oxygen. The use of such oxidizers can maximize the benefits and reduce shortcomings relative to other common oxidizer such as pure O₂ or pure N₂O. The oxidizers present environmentally friendly, high density, high performance, self pressurizing or partially self-pressurizing oxidizer which may not need to operate under deep cryogenic conditions. The advantages of mixtures of oxygen and oxides of nitrogen as oxidizers are discussed herein.

1. Definitions

An “oxide of nitrogen” refers to any species selected from the group consisting of nitric oxide (NO), nitrogen dioxide (NO₂), nitrous oxide (N₂O), dinitrogen tetroxide (N₂O₄), dinitrogen trioxide (N203) and dinitrogen pentoxide (N₂O₅). The term “oxide of nitrogen” also encompasses mixtures of these species in any ratio.

“Rocket” refers to a jet propulsion device that carries propellant on-board and does not rely on atmospheric oxygen as an oxidizer.

2. Oxidizers Comprising Oxygen and Oxides of Nitrogen
a. Preparation of Oxygen/Oxide of Nitrogen Mixtures

This invention provides compositions of matter comprising a mixture of oxygen and an oxide of nitrogen. The oxide of nitrogen can be a compound chosen from the group consisting of nitrous oxide, nitric oxide, nitrogen dioxide and dinitrogen tetroxide or a mixture thereof. The oxide of nitrogen can be selected as nitrous oxide. Various ratios of oxygen to oxide of nitrogen are envisioned, and the specific ratio can be selected as a function of the desired oxidizer properties such as temperature and pressure. Optimization of the mixtures is discussed in greater detail below. For examples, the desirable mass fraction of oxygen in the mixtures of the invention can range from 0.1 to 0.2, from 0.05 to 0.25, from 0.02 to 0.35 or from 0.02 to 0.50. In one embodiment, the mass fraction of oxygen is approximately 0.15.

In one embodiment, the present invention provides compositions comprising equilibrium liquid mixtures of oxides of nitrogen and oxygen. This system can comprise a liquid mixture and also a vapor mixture in phase equilibrium. The compositions can be stored in tanks for use in various applications. The phase equilibrium determines the oxidizer tank pressure and oxidizer density for a selected combination of temperature and oxidizer concentration in the mixture. As discussed below, the temperature and pressure can be selected to obtain the best oxidizer mass fraction, liquid density, and specific impulse combination for each specific application. The oxidizers of the invention can be prepared by following the standard techniques known in the art for dissolving gases in liquids. Mixtures of O₂ and N₂O have been used and studied in medical and dental applications as an anesthetic and are known to be highly miscible ( see, for example, Bracken et al, “Equilibria for Mixtures of Oxygen and Nitrous Oxide and Carbon Dioxide and Their Relevance to the Storage of N₂O/O₂ Cylinders for Use in Analgesia”, 1970). Techniques for preparing such mixtures are disclosed by Speece (U.S. Pat. No. 6,485,003) and Liou (U.S. Pat. No. 6,955,341) can also be implemented to produce the oxidizers of the invention.

In another embodiment, the oxidizers of the invention can be stored as equilibrium gaseous mixtures of oxides of nitrogen and oxygen. This would be a single phase oxidizer which could be readily obtained from commercial sources. For this configuration, the gas phase mixtures of oxides of nitrogen and oxygen would be expected to have better density than pure O₂ gas and better Isp performance compared to pure N₂O. The preparation and storage of such gaseous mixtures would be well within the grasp of a person skilled in the art.

In yet another embodiment, the oxidizer of the invention is a non-equilibrium liquid mixture of oxides of nitrogen and oxygen. These mixtures would potentially have better performance than the equilibrium mixtures since more oxygen can be loaded into the system at a given temperature. Non-equilibrium systems could be meta-stable for the short durations of operation typical in most rocket propulsion applications. The safe storage period is expected to depend on the extent of equilibrium and storage conditions.

In still another embodiment, the inventions equilibrium and non-equilibrium mixtures of oxygen and an oxide of nitrogen which is N₂O₄ or a mixture of nitrogen oxides. These mixtures exhibit similar density and pressure characteristics as the baseline oxygen/nitrous oxide system (mixture of N₂O and O₂) at elevated temperatures. Useful mixtures include, but are not limited to, N₂O/O₂/NO, N₂O/O₂/O₃ or N₂O/O₂/NO/O₃. The addition of NO into an oxygen/nitrous oxide system would add some additional pressurization capability and enhance the Isp performance and the reactivity of the oxidizer. Addition of small quantities of ozone (O₃) into an oxygen/oxide of nitrogen system could also be beneficial in terms of enhancing the decomposition rate of nitrous oxide and the Isp performance, and possibly improving motor stability and efficiency. Additional modifications are possible.

Addition of other ingredients to control the chemical reactivity or properties of the compositions of the invention can also be beneficial. As an example, this invention provides a composition comprising oxygen, an oxide of nitrogen and a gas that does not significantly enter into chemical reactions under combustion conditions typical in the propulsion systems of this invention (an “inert gas”). The addition of an inert gas reduces the sensitivity of oxygen/oxide of nitrogen mixtures to chemical decomposition. Suitable inert gases include, for example, nitrogen, helium, neon, xenon, krypton, or radon. Inert gases can be added to the oxidizers of this invention in a range from 0.5% to 20%. Small amounts of organic or inorganic fuel components can be incorporated to enhance the reactivity of the oxidizer. For example, methane can be added to an oxygen/nitrous oxide oxidizer composition. Addition of higher concentrations of fuels could result in a highly sensitive but also a high performance monopropellant that could be beneficial for certain propulsion applications. In a particular such embodiment, an oxidizer composition comprises between 1 and 30% methane by weight. Maximum Isp for mass fraction of methane for the 15% O₂/85% N₂O system is about 10%. Maximum Isp for mass fraction of methane for the 50% O₂/50% N₂O system is about 17%.

In another embodiment, this invention provides an oxidizer comprising oxygen and an oxide of nitrogen further comprising a gelling agent. Gelling agents useful in this invention include silicon dioxide or hydroxypropyl cellulose.

The fuel component should typically be selected such that it would be highly miscible with the oxidizers of the invention but would typically have a low vapor pressure at storage temperatures in order to minimize the possibility of a vapor phase explosion. Solid, liquid or gelled fuels can be mixed with the oxidizers.

The oxygen/oxide of nitrogen oxidizers can be used with liquid or solid fuels including but not limited to the general categories of saturated or unsaturated hydrocarbons, alcohols, hydrogen, amines, natural and synthetic polymers, waxes, silanes, metals, metal hydrides and boron compounds. Preferred metals include aluminum, beryllium, lithium, boron, magnesium, silicon, potassium and zirconium. Other useful metals include, without limitation, sodium, calcium, manganese, iron, cobalt, nickel, copper, zinc, lead, tin, antimony, gold and bismuth. Mixtures, liquid or solid solutions or emulsions of these fuels can also be used as the fuel component of a propellant. Suitable liquid or gaseous fuels for use in the invention include hydrogen; hydrocarbons such as methane, ethane, propane, butane, kerosene, or refined petroleum-type fuels; hydrazines, such as monomethyl hydrazine; fuels comprising boron such as diborane or pentaboranes. Additional fuels are known to persons skilled in the art and are described, for example, in U.S. Pat. Nos. 3,082,598; 3,153,901; 6,383,319; and 3,650,857.

Mixtures of fuel and the oxidizers of the invention can be gelled by the addition of relatively small amounts of gelling agent, as discussed above. In one embodiment, between 1 and 5% hydroxypropyl cellulose can be added while stirring to a mixture of oxidizer and fuel, thus resulting in a fuel gel slurry. Additional methods for the preparation of such slurries are described in U.S. Pat. Nos. 5,597,947; 3,352,109; and 3,447,915.
b. Properties of Oxygen/Oxide of Nitrogen Mixtures

The compositions of the invention can offer superior performance in various applications. The following considerations can help guide a person skilled in the art to apply the invention such that the performance benefits obtained are maximized.

Performance can be increased due to a number of factors. For instance, the disclosed oxidizers can be self pressurized even at high densities, which results in an oxidizer having higher density and thus higher performance compared to an oxidizer consisting of pure N₂O. Another advantage may be that in a system where the oxidizer is an oxygen/oxide of nitrogen mixture, the ullage gas is composed primarily of oxygen, which can be efficiently burned in a hybrid rocket configuration, thus resulting in greatly improved delivered specific impulse. If desired, performance can further be increased significantly by using compositions of the invention at thermodynamic non-equilibrium.

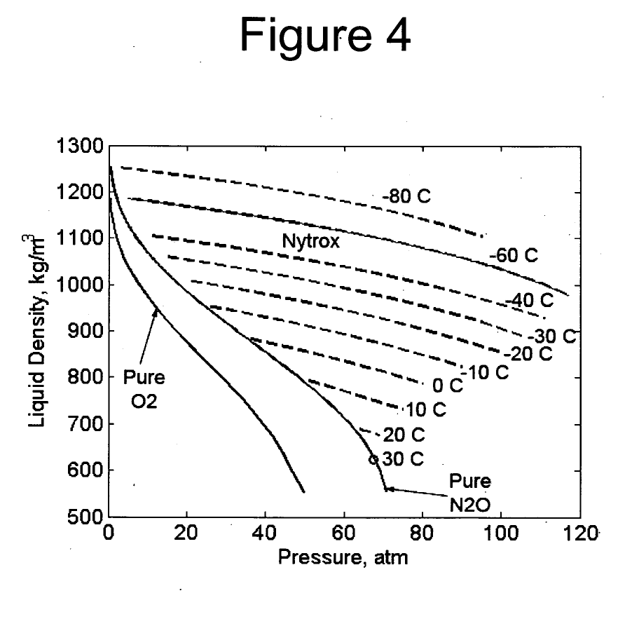

At a given pressure and temperature the molar fractions, mass fractions and densities for each phase can be estimated by using the Peng-Robinson equation of state and mixing rule. FIG. 4 shows the liquid densities estimated for the oxygen/nitrous oxide mixtures as a function of pressure at different temperatures. As a reference the liquid densities for pure substances (N₂O and O₂) are also included in the figure. For pure O₂ and N₂O, each point on the liquid density pressure curve is associated with a different temperature, since for a two phase, single component system, Gibbs' phase rule requires that a single intensive variable uniquely establishes the state of the substance. An important observation from FIG. 4 is that, at a selected pressure, the densities of the oxygen/oxide of nitrogen mixtures are significantly higher than the densities of the pure substances. The other important observation is that for the oxygen/oxide of nitrogen mixture at a given temperature, the liquid density is not very sensitive to the system pressure as long as the pressure is not close to the critical value at that temperature. This feature of the oxygen/oxide of nitrogen mixture gives a person skilled in the art the flexibility of selecting the system pressure without affecting the oxidizer density significantly.

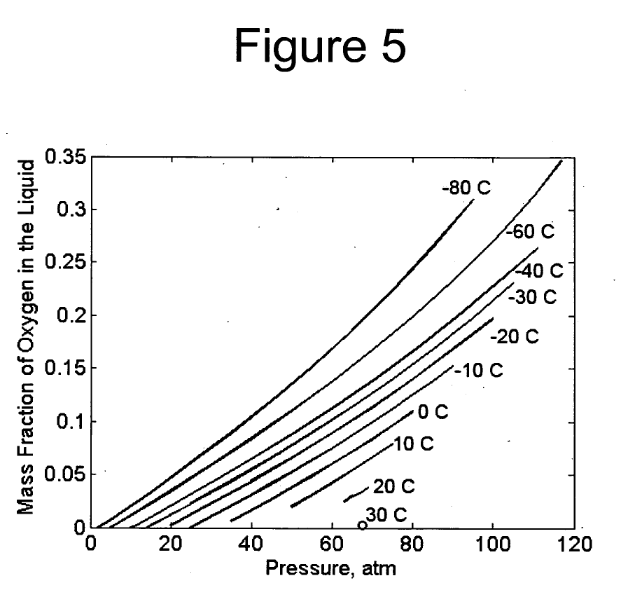

FIG. 5 shows the mass fraction of the oxygen in the liquid phase as a function of pressure for various temperatures. The general trend is that the oxygen mass fraction in the liquid increases with increasing pressure and decreasing temperature. As shown in the Figure at 60 atm pressure and −60° C., oxygen constitutes approximately 15% of the liquid mass.

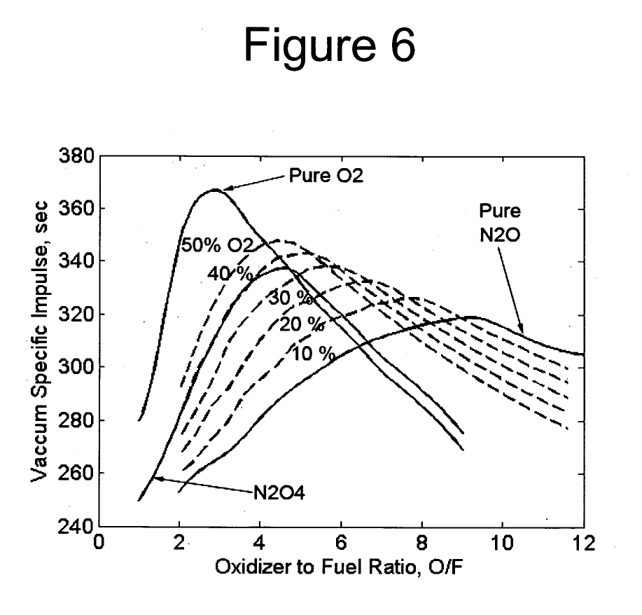

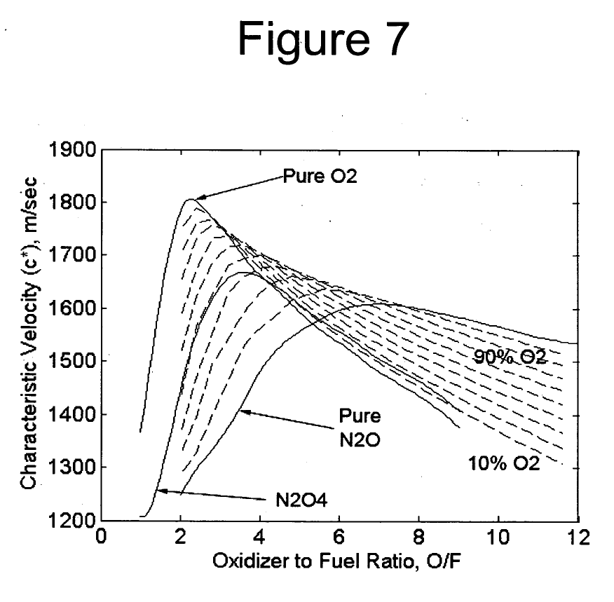

The specific impulse and c* performance of the oxygen/oxide of nitrogen mixtures at different oxygen concentrations have been calculated using the Air Force Astronautics Laboratory (AFAL) specific impulse (Isp) program. To produce this example, all calculations were conducted using paraffin as the fuel with a chamber pressure of 500 psi, the nozzle area ratio of 70 and ambient pressure of zero. The results are shown in FIGS. 6 and 7 for specific impulse and characteristic velocity (c*), respectively. The data for pure oxidizers, liquid oxygen, N₂O₄ and N₂O, are also included for reference. It is important to note that the oxygen/nitrous oxide mixture comprising 35% oxygen matches the Isp performance of N₂O₄. This represents an advantage of the present invention. In some application where the use of N₂O₄ as an oxidizer is problematic due to its toxicity, an oxidizer of the present invention could thus be used as a less hazardous alternative. It is also apparent that even at low oxygen concentrations (such as 10%) the performance benefit and the shift in the optimal oxidizer to fuel ratio (O/F) is significant.

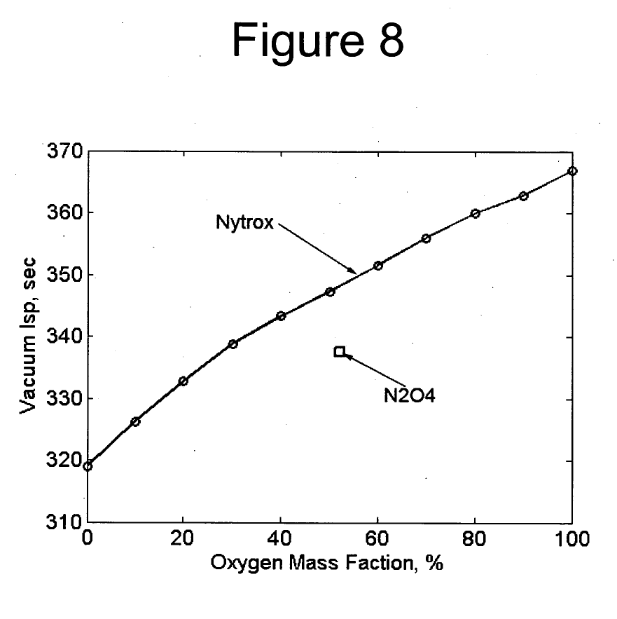

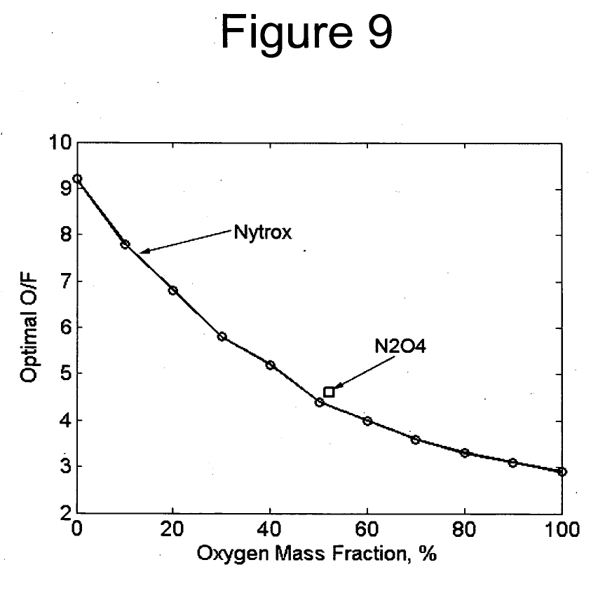

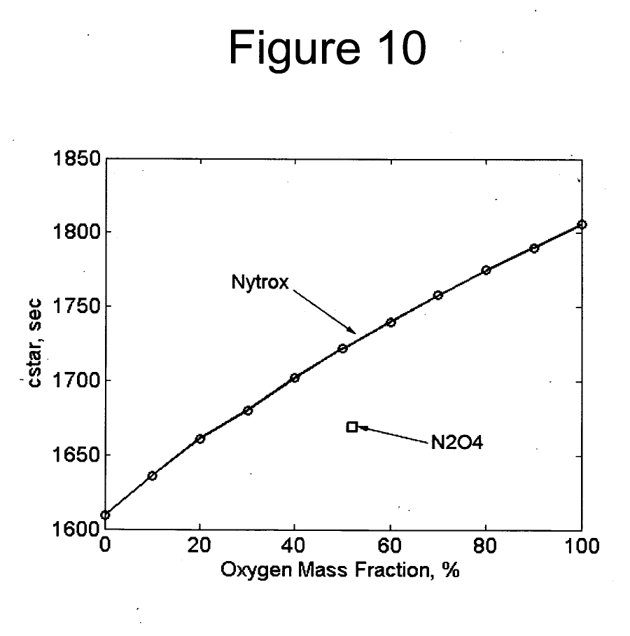

FIGS. 8 and 10 show the maximum Isp and c* as a function of the oxygen mass fraction. The oxygen/nitrous oxide mixture with oxygen mass fraction matching the inherent oxygen mass ratio of the N₂O₄ molecule outperforms N₂O₄ due to the negative heat of formation of the dinitrogen tetroxide molecule. A plot of the optimum O/F (corresponding to maximum Isp) as a function of oxygen mass fraction is included in FIG. 9.

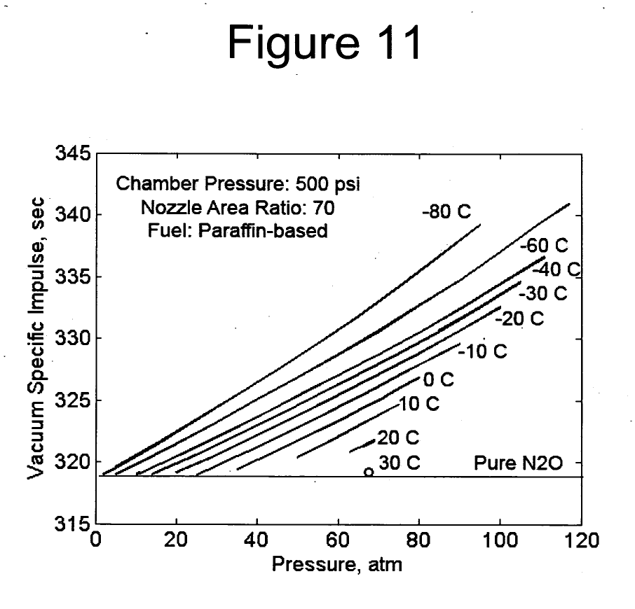

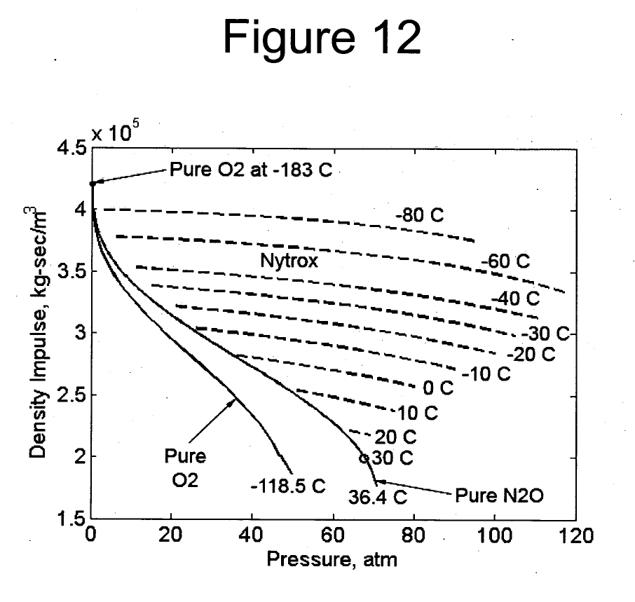

The performance of the equilibrium mixtures of O₂/N₂O is best summarized by FIGS. 11 and 12 which contain the plots of specific impulse and density impulse as a function of pressure at various temperatures. The specific impulse plot follows the oxidizer mass fraction trend given in FIG. 4 as expected. The density impulse, which is a product of density and specific impulse, follows the general trend of density (FIG. 4) since the variation of the density dominates the changes in Isp for the regime plotted in FIG. 12.

As can be seen in FIG. 12, the density impulse of the cryogenic LOX system at 14.7 psi of vapor pressure and - 183° C. is almost matched by the O₂/N₂O mixture at −80° C. and 60 atm of vapor pressure. The elimination or minimization of the external pressurization system and the higher temperature operational capability (ability to use composite tanks) would favor the oxygen/oxide of nitrogen mixture for a wide range of applications in which low cost and operational simplicity is crucial.

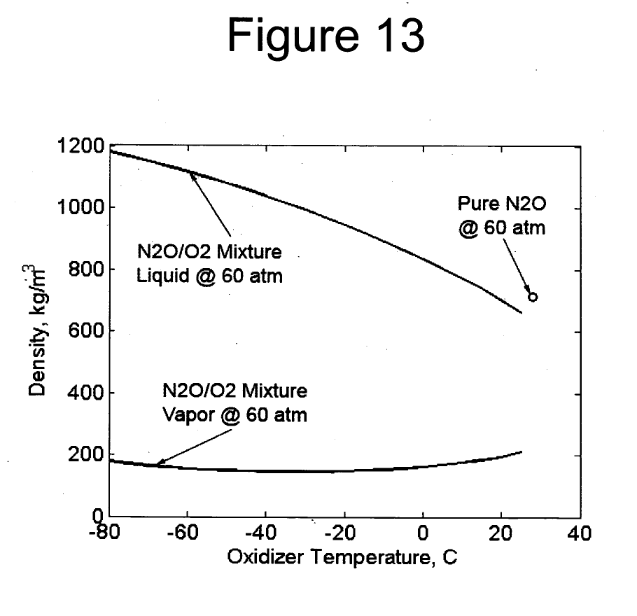

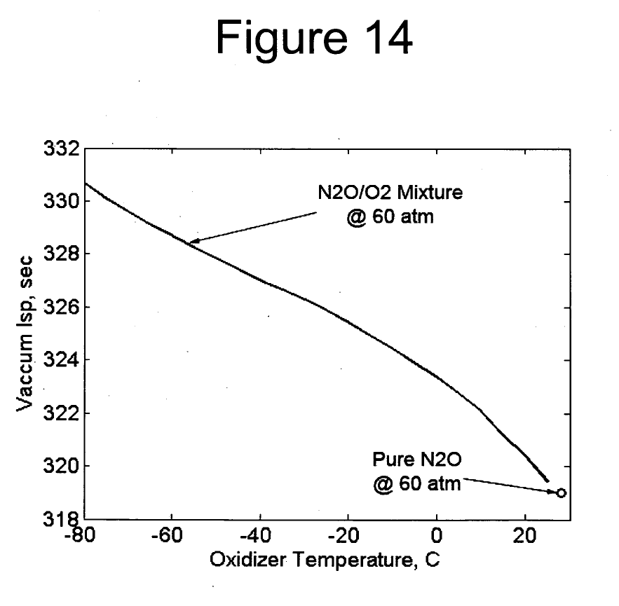

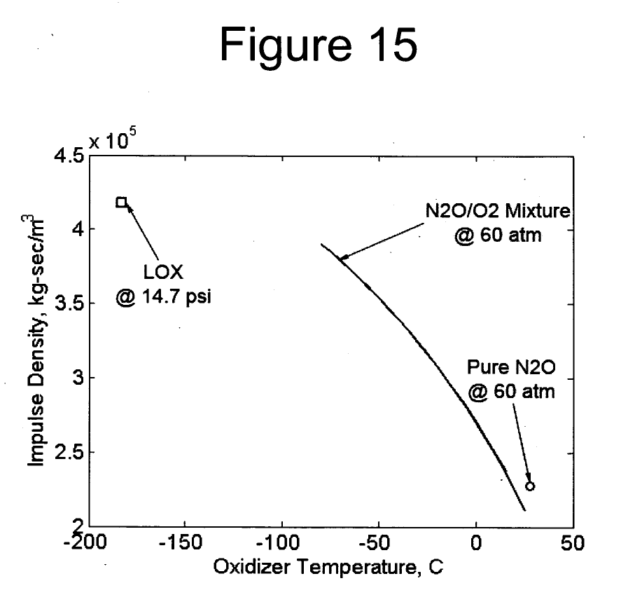

As an example case, the performance of an O₂/N₂O system operating at 60 atm has been calculated for various temperatures. The results are shown in FIGS. 13, 14 and 15. As indicated in FIG. 14, a system operating at −60 C has approximately 10 seconds of Isp advantage over the pure N₂O system. More remarkably the system has almost 70% improvement in the density impulse over the pure N₂O oxidizer.

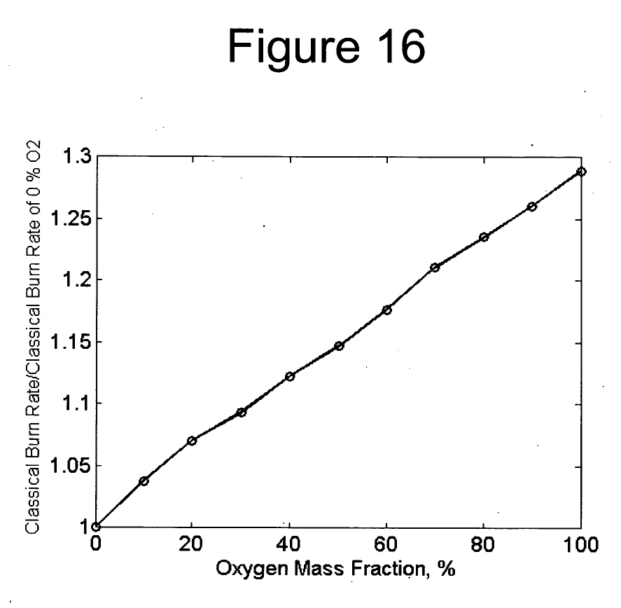

Classical hybrid rocket combustion theory as developed by Marxman et al. (“Fundamentals of Hybrid Boundary Layer Combustion”, 1964) can be applied to predict the effect of the oxygen mass fraction on the regression rate for generic solid hydrocarbon fuels. The results are plotted in FIG. 16. Note that an increase of 29% in the regression rate is predicted by the classical theory as the mass fraction of O₂ is increased from 0% to 100%. This prediction is fairly close to the measured bum rates for the two oxidizers with various fuel systems.
c. Safety Advantages of Oxygen/Oxide of Nitrogen Mixtures as Oxidizers

Another advantage of the invention relates to improved storage and handling properties. For example, the explosion hazard of the compositions of the invention may be significantly reduced compared to pure N₂O. The vapor phase for liquid mixtures of oxygen and oxides of nitrogen is mostly oxygen, making decomposition of the vapor phase unlikely. Additionally, it has been noted that decomposition reactions cannot be sustained in low temperature liquid N₂O. See, for example, Rhodes, “Investigation of Decomposition of Characteristics of Gaseous and Liquid Nitrous Oxide”, 1974. In a related aspect, oxygen/oxide of nitrogen mixtures can be stored and used at higher temperatures than oxygen. For example, the oxidizer of the invention can be stored at −60° C. or −40° C., making it possible to use light weight composite tanks for storage rather than the cryogenic tanks used for the storage of liquid oxygen. Thus, the hazards associated with the handling of large quantities of cryogenic liquids are diminished.

Similar to hydrogen peroxide (H₂O₂) or hydrazine (N₂H₄), nitrous oxide is a monopropellant (it exothermically decomposes into N₂ and O₂). The ignition of nitrous oxide (primarily the vapor phase) can take place homogenously when the material is uniformly heated to a temperature larger than its autoignition temperature (approximately 880 K) or locally when enough energy (or free radicals) is locally introduced to the vapor at lower temperatures such that a self sustaining deflagration wave (flame) can start to propagate in the medium. Local thermal ignition is the most common failure mode observed in rocket propulsion applications, since it is rather difficult to heat large quantities of nitrous oxide to the auto-ignition temperature within the short periods that the rocket operation takes place. Nitrous decomposition events have commonly been observed in the testing of rocket motors.

A more dangerous mode of failure is the decomposition of the N₂O vapor in the oxidizer tank. Due to the large quantities of N₂0 in the tank ullage, a decomposition process in the tank could potentially produce large explosions resulting in injury to personnel and/or major hardware loss. The likelihood of decomposition may increase in larger tanks due to the decrease in surface to volume ratio as the tank size grows, which can be a problem especially for propulsion systems with a closely coupled oxidizer tank and combustion chamber. For such systems, at the end of the liquid bum, the hot injector could potentially heat the nitrous vapor in its vicinity and start a deflagration wave that would propagate in the tank. For pure nitrous oxide in a closed vessel at 300° K, complete decomposition would result in an 11 fold increase in the tank pressure, a number which is much larger than the safety factor of known flight tanks and most run tanks used for ground testing. This indicates that even a partial decomposition could lead to a structural tank failure and loss of mission.

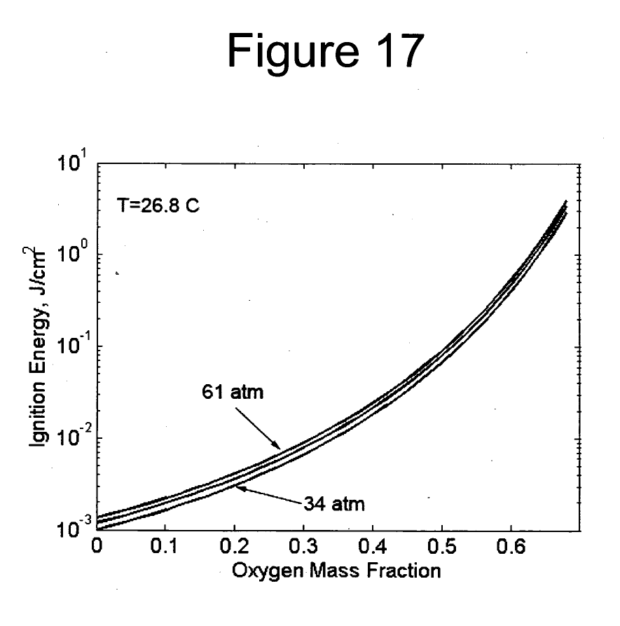

The safety advantage of the oxidizers of the invention over N₂O can be provided to some extent by the dilution effect of O₂. The vapor phase of the oxygen/nitrous oxide system has a large O₂ concentration, in the range of 50-90% by mass (see FIG. 17). The minimum energy to start a self sustaining deflagration wave in nitrous oxide with varying initial concentration of oxygen is shown in FIG. 17 for three initial pressure levels 34, 48 and 61 atm. Note that the calculations are conducted for a hot plate in a vessel filled with a N₂O/O₂ gas mixture, a configuration which mimics the situation in a hybrid system at the end of the liquid bum. As indicated in the figure, a typical oxygen/nitrous oxide system with 70% oxygen by mass in the vapor phase requires 2,000 times more ignition energy compared to pure nitrous oxide. In summary, the vapor phase of oxygen/oxides of nitrogen systems would be very difficult to ignite with any ignition source that might exist in the tank. The Figure also shows that at the high pressure levels relevant to rocket applications, the effect of pressure is small compared to the effect of dilution.

Oxygen/oxide of nitrogen mixtures can additionally present significant safety advantages compared to the use of liquid oxygen due reduced cryogenic and fire hazards. The safety advantages of the oxidizers of the invention would thus have a substantial effect in reducing the development and operational costs associated with propulsion systems.
d. Additional Advantages of the Oxidizers of the Invention

Mixtures of liquid oxygen and nitrous oxide are expected to have a lower freezing point compared to pure N₂O. This feature can be particularly useful in space applications, due to the low temperatures at high altitudes and in space.
e. Optimization of Oxygen/Oxide of Nitrogen Oxidizers

The present invention offers improved flexibility to a person skilled in the art wishing to optimize applications such as power and gas generation or propulsion. Critical control variables for optimization may be the temperature and pressure, which determine the oxidizer mass fraction in the fuel-oxidizer mixtures. A system may thus be optimized based on specific mission requirements, which, in turn, can significantly reduce development and operational costs. As an example a comparison of the pure O₂, N₂O and oxygen/nitrous oxide mixtures in various critical areas are summarized in Table 1. The table shows the clear advantage of the mixtures over the pure substances in many key aspects which would allow the designer to formulate an oxidizer well tuned to the particular application of interest.

TABLE 1
Comparison of pure O₂, N₂O and mixtures of oxygen/nitrous oxide as
oxidizers.

| Feature | O₂ | N₂O | O₂/N₂O |
|---|---|---|---|
| Isp Performance | 5 | 3 | 4 |
| Density | 4 | 2 | 4 |
| Impulse Density | 4 | 1 | 3 |
| Chemical Stability (Explosion Safety) | 5 | 2 | 4 |
| Toxicity | 5 | 4 | 4 |
| Storability | 1 | 5 | 3 |
| Self Pressurization Capability | 1 | 5 | 3 |
| Gas Phase Combustion | 1* | 2 | 4 |
| Hypergolicity | 1 | 1 | 1 |
| Ease of Handling | 3 | 5 | 4 |
| Material Cost | 5 | 4 | 4 |
| Chemical Compatibility | 5 | 5 | 5 |
| Performance Tuning Capability | 1 | 2 | 5 |
| Motor Stability/Efficiency | 1 | 5 | 4 |
| Freezing Point | 5 | 3 | 4 |

5: Best performance,
1: Worst performance
*He pressurization

It is important to determine the properties of the equilibrium mixtures of oxygen and nitrous oxide in order to quantify the performance benefits outlined above. For this purpose, the present invention discloses equations allowing the properties of the mixtures to be predicted. These predictions are based on the Peng-Robinson equation of state, which is well suited for this application because it is formulated to be accurate at elevated pressures including the critical region. Another advantage of the Peng-Robinson equation of state is that it requires only one adjustable parameter for binary mixtures. A detailed description of the Peng-Robinson equation of state and of its use in predicting the properties of the oxidizers of the invention is given in the Examples section.

3. Applications

The oxygen/oxide of nitrogen oxidizers can be used as the oxidizing component of the propellant system in propulsion, gas generation and power production applications. Applications include hybrid rockets, bipropellant liquid rocket, monopropellant liquid engines, tripropellant rocket engines, gas generator systems, thrust augmented solid fuel ramjets or liquid fueled ramjets, mass injection turbojet/turbofan cycles, combined cycle propulsion systems such as turborockets and internal combustion engines.

Various devices are envisioned which take advantage of the oxidizers of the invention. In rocket engines, oxidizer and fuel can be stored in different tanks and mixed together in the combustion chamber. Accordingly, this invention contemplates systems in which the oxidizers of this invention are held in a single tank or in separate tanks for subsequent mixing.

In one aspect, a device can comprise a first container comprising an oxidizer comprising oxides of nitrogen and oxygen, a second container comprising a fuel, a combustion chamber and an outlet. The combustion chamber can be in fluid or gaseous connection with the first container, the second container, or both, and may allow the combustion of a mixture of oxidizer and fuel to produce combustion gases. Various means can be used to feed oxidizer, fuel, or a mixture thereof into the combustion chamber. For instance, the contents of the first and second containers can be transported through supply pipes or lines into the combustion chamber. The pressure necessary for this process can be provided by pumps or by another pressurizing agent. In some cases, the energy necessary to drive the pumps can be provided by combustion gases driving a turbine in connection with the pumps or in connection with a compressor. In some cases, the device can be a self-pressurized system in which the pressure can be provided entirely or partially by the oxidizer or fuel itself. Supply lines can be cooled or heated as necessary to ensure optimal delivery into the combustion chamber. Pre-combustion and/or mixing chambers can also be present in some devices. An ignition system can be connected to the combustion chamber. Suitable containers for use in this device can be storage tanks. Such tanks are well-known in the art and can have different properties depending on the specific application. For example, containers can be composite storage tanks or metal storage tanks. Non-limiting examples include those described in U.S. Pat. Nos. 6,158,605; 6,491,259; 6,837,464; 3,001,376 and 2,902,822. In general, an outlet allowing the release of combustion gases is provided. Such an outlet can comprise a nozzle such as a de Laval nozzle, which accelerates the combustion gases to maximize thrust. This would generally be desirable when the device is used for propulsion. Examples of such nozzles are described in U.S. Pat. Nos. 3,372,548; 4,063,684 and 4,029,844. Alternatively, the outlet can be configured such that the combustion gases are used to drive a turbine. Such a configuration could be particularly useful in power generating applications. See, for example, U.S. Pat. Nos. 4,805,411; 4,374,466; 4,052,844 and 6,155,040.

In another aspect of the invention, a device can comprise a container comprising an oxidizer comprising oxygen, wherein the pressure within the container is between about 5 and 200 atm, and wherein the temperature within the container is between −100° C. and 20° C., and further wherein the mass fraction of oxygen within the container is between about 0.02 and 0.5. In some embodiments, the pressure within the first container is between about 5 and 120 atm, the temperature within the container is between −80° C. and 10° C., and the mass fraction of oxygen within the container is between about 0.02 and 0.35. The indicated ranges of values for operating parameters such as temperature, pressure and oxygen mass fraction may be particularly suitable in many applications. A person skilled in the art would understand to apply the disclosure of the invention to select appropriate values for each parameter. For example, a person wishing to use an oxidizer that offers the same Isp performance as a pure N₂O₄ oxidizer could select a mixture of oxygen and nitrous oxide comprising 35% oxygen (see FIG. 8). The optimal oxidizer/fuel ratio can then be determined as 6 based on FIG. 9. Such an oxidizer could be used in a device at an operating temperature of −60° C. and an operating pressure of 120 atm.
a. Rockets

In one aspect of the invention, the device of the invention can be a liquid rocket, in which propellants are stored in liquid form. The liquid rocket can be a monopropellant, bipropellant or tripropellant rocket. A monopropellant rocket of the invention generally can comprise a container comprising a mixture of an oxide of nitrogen, oxygen and a fuel. A device which is a bipropellant or tripropellant rocket can comprise a container storing the oxidizer and an additional container storing the fuel. Any or all of the containers can be in fluid or gaseous connection with each other and with a combustion chamber to which an outlet is attached, allowing expulsion of combustion gases. In one embodiment, each container is separately in connection with the combustion chamber, allowing the fuel and oxidizer to mix within the combustion chamber. Alternatively, the device can be configured such that the fuel and oxidizer are mixed prior to injection into the combustion chamber. In a related embodiment, the device is self-pressurized. In other embodiments, pressurization is achieved using other means, such as another gas or by using pumps. Various configurations of liquid rockets can be used in the invention. Examples are disclosed, for example, in U.S. Pat. Nos. engines 1,103,503 and 3,882,676.

In another embodiment, the device of the invention can be a hybrid rocket comprising a solid fuel and an oxidizer comprising a mixture of oxygen and oxides of nitrogen. Suitable solid fuels for use in the invention include all solid fuels known in the art, including polymers such as ABS plastic or rubber, waxes such as paraffin or metals such as aluminum. In related embodiments, oxidizers of the invention can be contacted with the solid fuel prior to or during combustion. The solid fuel may contain some solid oxidizers such as ammonium perchlorate, amonium nitrate, potassium perchlorate or potassium nitrate. For certain applications, the addition of the solid oxidizer can be beneficial due to the enhanced regression speed of the fuel and reduced mass fraction of liquids in the system. The solid fuel can be stored lining a combustion chamber. Upon contact with the oxidizers of the invention, an exothermic reaction results in the production of large volumes of gas. The reaction products can be expelled through a nozzle. Hybrid rockets are known in the art and are described, for example, in U.S. Pat. Nos. 4,424,679 and 5,582,001.

In another embodiment, the device of this invention can configured as a solid rocket. In such a case, the oxidizer of this invention is mixed homogenously or heterogeneously with a fuel and cooled to a temperature at which the composition freezes, e.g., below −90° C. (e.g., −100° C. to −150° C.). The material is enclosed in a chamber. Upon ignition the solid material combusts and produces hot gases that can be expelled to produce the require thrust force.
b. Air-breathing Jet Engines

This invention also contemplates air-breathing jet engines in which oxidizers of this invention complement atmospheric oxygen as an oxidizer. These include, for example, turbojets, turbofans, turboprops, ramjets and scramjets. In these embodiments the device of the invention can comprise an air inlet and means for compressing air, such as an air compressor, in the case of turbojets, turbofans and turboprops, or an intake passage shaped to compress the air, in the case of a ramjet or scramjet. These engines have an outlet which can be shaped in the form of a nozzle to produce thrust. In other embodiments, the engine further comprises an afterburner. In turbo-devices the air is compressed with a turbine that can be turned using the combusted gases. Both high- and low-bypass engines are encompassed by the present invention. Various jet engine designs are known in the art and are disclosed, for example, in publications such as U.S. Pat. Nos. 5,351,480; 4,224,790; 3,260,046; 5,480,107 and 3,570,250. Examples of ramjet designs are described in U.S. Pat. Nos. 4,291,533; 3,974,648; 3,901,028; 4,185,457; 3,430,446;

3,635,029 and 3,161,018.

It is contemplated that oxidizer in such engines comprises a mixture of air provided through an air inlet as well as a second oxidizer stored as part of the device, wherein the second oxidizer is an oxidizer as provided by the invention. The mixtures of oxidizes of nitrogen and oxygen can be stored in a tank on the aircraft. The mixture would be injected into the turbojet engine (or internal combustion engine) for thrust augmentation or to prevent flame out at high altitudes and/or during rigorous maneuvering. This configuration improves operation at higher altitudes where oxygen in the air is scarce. The extra oxidizer can be injected at the upstream of the compressor, at the intermediate stages of the compressor, at the combustion chamber or at the afterburner.
c. Power Generators

The present invention can also be used in power production applications. Devices for power production applications include, for example, gas turbines. In general, a gas turbine comprises an air compressor, a combustion chamber, a turbine and an exhaust system. The oxidizers of the invention can be used in such applications by injection into the combustion chamber, or alternatively the oxidizer can be mixed with a fuel prior to combustion in the combustion chamber. Examples of gas turbines for use in the invention are disclosed in U.S. Pat. Nos. 5,695,319; 6,260,350;

4,659,245; 3,469,396; 3,782,108 and 3,818,695.
d. Gas Generators

Devices of the invention can also be devices for the production of large volumes of gas such as gas generators. A gas generator can be similar in some aspects to a rocket engine, but may be optimized to produce large volumes of relatively cool gas rather than maximizing the thrust or power obtained. Gas generators can be used, for example, to power turbopumps in rocket devices, to deploy airbags, to power torpedoes, and in other cases where large volumes of gas may be needed. Examples of gas generators known in the art are disclosed in U.S. Pat. Nos. 3,985,076;

3,773,351; 5,094,475; 3,934,984; 5,149,129 and 5,345,875.
e. Internal Combustion Engines

In another embodiment, the oxidizer of this invention is used in connection with internal combustion engines, such as those used to power automobiles (e.g., as supercharged racing cars), boats and air craft. In this case the device carries an external tank comprising the oxidizer. The oxidizer feed line is used to feed the oxidizer from the tank into the engine manifold. When the excess power is needed, the oxidizer is introduced into the cylinders (along with the air) by the opening of a valve in the feed line.
f. Additional Applications

Additional applications for the oxidizers of the invention are combined cycle propulsion or combined cycle power generating systems. Such systems can, for example, integrate several rocket and air breathing propulsion modes into one engine. Combined cycle gas turbines can also represent devices where the oxidizers of the invention can be used. A person skilled in the art would know how to apply the oxidizers of the invention to a variety of such devices where appropriate.

In one embodiment also encompassed by the invention, a pure oxide of nitrogen can be pressurized by gaseous oxygen present in the ullage of a storage tank. Some of the oxygen can be absorbed into the liquid oxide of nitrogen oxidizer (e.g. N₂O, N₂O₄ or a mixture of nitrogen oxides) and an equilibrium composition at a given temperature can be obtained. This mode of operation can be useful, for example, in propulsion devices, because such a device could potentially be started well before system equilibrium is reached. An advantage of using such oxygen pressurization as opposed to a pure ‘blow down’ system (such as pure N₂O operating at room temperature) or pressurization using an inert gas (i.e. He or N₂) is that full combustion during the vapor flow stage of the system operation (following the depletion of all the liquid in the oxidizer tank) is expected and the pressurant gas contributes significantly to the total impulse increasing the efficiency of the overall propulsion system.

### EXAMPLES

### Example 1

Determination of the Properties of Pure Systems and Mixtures using the Peng-Robinson Equation of State.

As discussed by Peng and Robinson (“New Two Constant Equation of State”, 1976), the Peng-Robinson equation of state (EOS) which is given by Eq. 1 is widely used for pure systems and mixtures due to its simplicity and higher accuracy (especially at high pressures) compared to the other cubic EOS such as Soave-Redlich-Kwong equation.

$$P = \frac{RT}{v - b} - \frac{a ( T )}{v ( v + b ) + b ( v - b )} , \qquad ( 1 )$$

Here P, T, v are pressure, temperature and molar volume, respectively and R is the gas constant. Note that the attraction parameter, a, is a function of temperature and the van der Waals covolume, b, is constant. For most applications it is convenient to express Eq. 1 in the following cubic form.

Z³−(1−B)Z²+(A−3B²−2B)Z−(AB−B²−B³)=0 (2)

Here the coefficients A and B and the compressibility Z are defined as

$$A = \frac{aP}{{R}^{2} {T}^{2}} , B = \frac{bP}{RT} and Z = \frac{Pv}{RT} . \qquad ( 3 )$$

Note that in the two phase region, the largest root of Eq. 2 corresponds to the compressibility of the vapor phase whereas the smallest root is the compressibility of the liquid phase.

At the critical point the attraction parameter, van der Waals covolume and the compressibility become

$$a ( {T}_{c} ) = 0.45724 \frac{{R}^{2} {T}_{c}^{2}}{{P}_{c}} , b ( {T}_{c} ) = 0.07780 \frac{{RT}_{c}}{{P}_{c}} and {Z}_{c} = 0.307 . \qquad ( 4 )$$

For all other temperatures the two coefficients can be written as

a(T)=a(T_{c})α(Tᵣ, ω) and b(T)=(b(T_{c}). (5)

Note that α is a function of the reduced temperature, Tᵣ, and the acentric factor, ω, for the particular molecule.

α^{1/2}=1+m(1−Tᵣ^{1/2}) and m=0.37464+1.54226ω−0.26992ω² (6)

The reduced temperature is defined as

$${T}_{r} = \frac{T}{{T}_{c}} \qquad ( 7 )$$

The following parameters can be used for nitrous oxide and oxygen:

ω_{N2O}=0.162 (T_{c})_{N2O}=309.6K (P_{c})_{N2O}=71.6 atm

ω_{O2}=0.02 (T_{c})_{O2}=154.7K (P_{c})_{O2}=49.8 atm

The fugacity, f, of a single component can be expressed as

$$ln ( \frac{f}{P} ) = Z - 1 - ln ( Z - B ) - \frac{A}{2 \sqrt{2 B}} ln ( \frac{Z + 2.414 B}{Z - 0.414 B} ) \qquad ( 8 )$$

Note that at phase equilibrium the fugacities of the liquid and the vapor should be matched.

f^{l}=f^{v} (9)

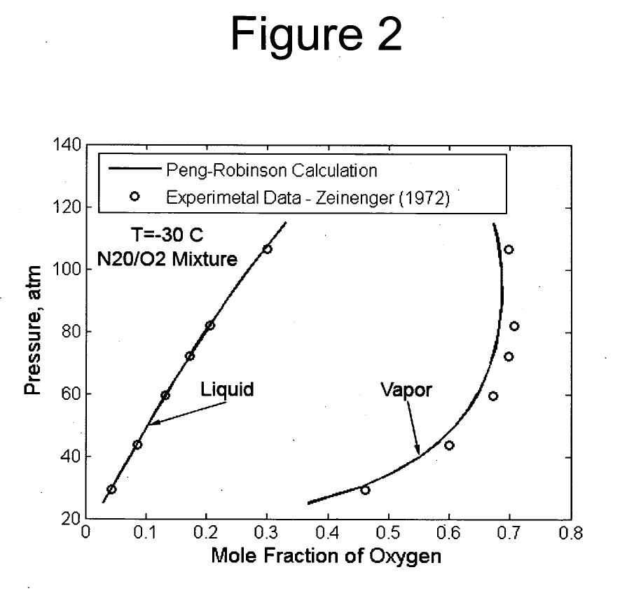

The phase data for the oxygen-nitrous oxide mixtures has been reported by Zeinenger (“Flussikeits/Dampf-Gleichgewichte der Binaren Systeme N₂O/N₂, N₂O/O₂ und N₂O/CH₄ bei Tiefen Temperaturen und Hohen Drucken” 1972) and Bracken et al. over a limited range of temperatures. Zeinenger lists vapor and liquid mixture data for temperatures in the range of −60 C to 20 C, whereas Bracken et al. reports results for temperatures between −30 C and 30 C. Both data sets have been included in our study to determine the variation of the interaction parameter, k₁₂, as a function of temperature. As an example for the O₂/N₂O system at −30 C, the mole fractions of oxygen in the liquid and vapor phases have been calculated using the Peng-Robinson equation of state and plotted in FIG. 2. The phase equilibrium data from Bracken et al. has also been included in the figure. The fit for the liquid branch is excellent, whereas the predicted oxygen mole fractions in the vapor phase are somewhat low. However, it is clear that even in the vapor phase, the error appears acceptable and close to the accuracy of the experimental results. The Peng-Robinson interaction parameter that gives the best fit (shown in FIG. 2) for this particular temperature is 0.0819. The deviation from an ideal mixture (which requires an interaction parameter of zero) is small but finite.

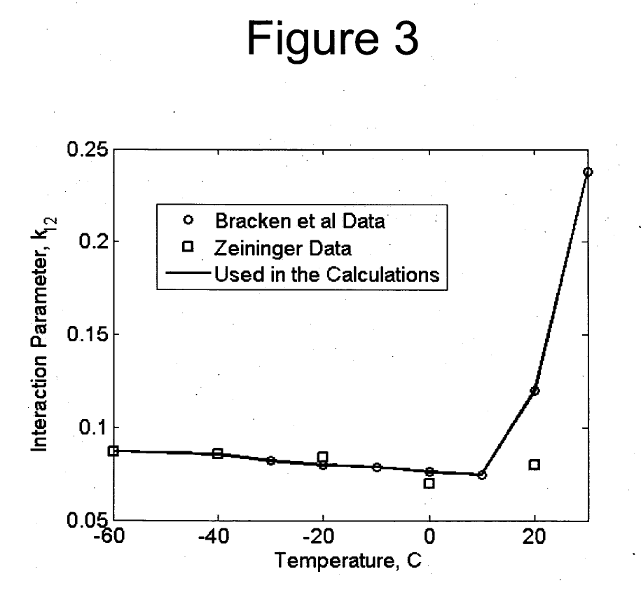

The process described in the previous paragraphs has been repeated for all of the data at varying temperatures as they are reported by Zeinenger and Bracken et al. The interaction parameter, k₁₂, values obtained as a best fit to the experimental data has been plotted as a function of temperature in FIG. 3. Using standard analysis and curve fit techniques, it has been determined that the data given by Bracken et al. is more reliable than the data reported by Zeinenger and the k₁₂ fit used in the calculations have been based on the Bracken et al. data in the temperatures ranging from −30 C to 30 C. For temperatures between −30 C and −60 C the values obtained from the Zeinenger data has been used. Note that other than the 20 C case, the k₁₂ values obtained from two data sets are in reasonably good agreement. The exact form of the k₁₂ curve is governed by the change of intermolecular interactions with temperature and the observed convex shape is consistent with the results reported for other mixtures such as methane/decane.

### Example 2

### Predicting the Properties of Equilibrium Mixtures:

It has been determined that a single parameter (k₁₂) binary mixing rule used in conjunction with the Peng-Robinson equation of state results in predictions that are in reasonably good agreement with the experimental findings.

The following “mixture rule” which is recommended by Zudkevitch and Joffe (1976) is commonly used for predicting the properties of non-ideal solutions of fluids as applied to the above EOS.

$$\begin{matrix}a = {\sum }_{i = 1}^{N} {\sum }_{j = 1}^{N} {x}_{i} {x}_{j} {a}_{ij} & ( 10 a ) \\ b = {\sum }_{i = 1}^{N} {x}_{i} {b}_{i} & ( 10 b ) \\ {a}_{ij} = ( 1 - {k}_{ij} ) {( {a}_{i} {a}_{j} )}^{1 / 2} & ( 10 c )\end{matrix}$$

Here xᵢ refers to the mole fraction of the i^{th} component. The interaction coefficient, kᵢⱼ, accounts for the interaction between the molecules and it is typically experimentally determined. For an ideal solution, kᵢⱼ is zero and deviation from zero indicates strong molecular interaction. In general, the interaction parameter is a function of temperature and it typically takes a minimum value. This fact has been demonstrated in FIG. 2 for the N₂O/O₂ mixture but also has been observed for many other mixtures such as methane/butane or methane/decane. The reason for the minimum is believed to be due to the strong interaction in the liquid phase at low temperatures and strong interaction in the vapor phase at high temperatures.

The fugacity of the k^{th} component in the mixture can be expressed as

$$ln ( \frac{{f}_{k}}{{Px}_{k}} ) = \frac{{b}_{k}}{b} ( Z - 1 ) - ln ( Z - B ) - \frac{A}{2 \sqrt{2 B}} ( \frac{2 {\sum }_{i = 1}^{N} {x}_{i} {a}_{ik}}{\dot{a}} - \frac{{\dot{b}}_{k}}{b} ) ln ( \frac{Z + 2.414 B}{Z - 0.414 B} ) . \qquad ( 11 )$$

Note that the equilibrium composition of the mixture can be obtained from the following condition for equilibrium.

fₖ^{l}=fₖ^{v}

For binary mixture of oxygen and nitrous oxide the “mixing rule” reduces to

a=a_{O2}x_{O2}²+2a₁₂x_{O2}(1−x_{O2})+a_{N2O}(1−x_{O2})² (13a)

b=b_{O2}x_{O2}+b_{N20}(1−x_{O2}) (13b)

a₁₂=(1−k₁₂)(a_{O2}a_{N2O})^{1/2} (13c)

### Example 3

### Determining Isp and Impulse Density for an Oxidizer of the Invention Based on the Density and Oxygen Mass Fraction.

It is instructive to use an example to illustrate the method of determining the critical performance parameters (such as Isp and impulse density) for various mixtures of oxygen/nitrous oxide oxidizers. These performance parameters are needed in the design calculations of an operational system. For the purposes of this example, we arbitrarily select an initial tank temperature and pressure of −40 C and 60 atm, respectively. Note that the density and oxygen concentration in the liquid phase are the two critical state variables that are needed to estimate the propulsion system parameters. In order to obtain these state variables, one can use a proven mixture rule and equation of state combination.

### Example 4

Determination of the Mass Fraction of Oxygen in an Oxidizer of the Invention based on the Desired Pressure and Temperature of Operation.

Assuming a desired pressure of 60 atm and a desired temperature of −40° C., FIG. 4 can be used to read a liquid density value of 1,070 kg/M³. Similarly, from FIG. 5, the oxygen mass fraction in the liquid phase can be determined to be 0.12. For this particular mixture, by using a standard thermochemical calculator (such as NASA Glenn's CEA program), one can calculate the maximum specific impulse for a selected fuel, nozzle area ratio and combustion chamber pressure. Specifically for a paraffin-based fuel, a nozzle area ratio of 70, and a chamber pressure of 50 atm, a maximum specific impulse value of 327 s has been estimated.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A composition of matter comprising a mixture of oxygen, an oxide of nitrogen and a fuel.

2. The composition of claim 1, wherein the oxide of nitrogen is a compound chosen from the group consisting of nitrous oxide, nitric oxide, nitrogen dioxide and dinitrogen tetroxide.

3. The composition of claim 2, wherein the oxide of nitrogen is nitrous oxide.

4. The composition of claim 1, wherein the mass fraction of oxygen ranges from 0.02 to 0.5.

5. The composition of claim 1, wherein the mass fraction of oxygen is about 0.15.

6. The composition of claim 1, wherein the mixture comprises a vapor.

7. The composition of claim 1, wherein the mixture comprises a liquid.

8. The composition of claim 1, wherein the mixture comprises a solid.

9. The composition of claim 1, wherein the oxide of nitrogen is in gaseous form.

10. The composition of claim 1, wherein the oxide of nitrogen is in liquid form.

11. The composition of claim 1, wherein the oxygen is substantially in liquid form.

12. The composition of claim 1, wherein the fuel is in solid form.

13. The composition of claim 1, wherein the fuel is in liquid form.

14. The composition of claim 1, wherein the mixture is at thermodynamic equilibrium.

15. The composition of claim 1, wherein the mixture is in not at thermodynamic equilibrium.

16. The composition of claim 1, wherein the mixture additionally comprises methane.

17. The composition of claim 1, wherein the mixture additionally comprises O₃.

18. A composition of matter comprising a mixture of an oxide of nitrogen, oxygen and a gelling agent.

19. The composition of claim 18, wherein the oxide of nitrogen is a compound chosen from the group consisting of nitrous oxide, nitric oxide, nitrogen dioxide and dinitrogen tetroxide.

20. The composition of claim 18, wherein the gelling agent is silicon dioxide.

21. A composition of matter comprising a mixture of an oxide of nitrogen, oxygen and an inert gas.

22. The composition of claim 21, wherein the oxide of nitrogen is a compound chosen from the group consisting of nitrous oxide, nitric oxide, nitrogen dioxide and dinitrogen tetroxide.

23. The composition of claim 21, wherein the inert gas is He.

24. A composition comprising a mixture of oxygen, an oxide of nitrogen and a compound in a mass fraction of at least 0.1%, wherein the compound is selected from NO, O₃ and a fuel.

25. The composition of claim 24 wherein the fuel is a fully saturated hydrocarbon.

26. A device comprising a container containing a mixture of oxygen and an oxide of nitrogen, wherein the temperature of the mixture is no greater than −60° C.

27. The device of claim 26 wherein the temperature of the mixture is between −60° C. and −90° C.

28. A device comprising:
(a) a first container comprising an oxidizer comprising an oxide of nitrogen and oxygen;
(b) a second container comprising a fuel;
(c) a combustion chamber in fluid or gaseous connection with the first container and/or with the second container, wherein the combustion chamber allows the combustion of a propellant comprising a mixture of the oxidizer and the fuel to produce combustion gases; and
(d) an outlet allowing the release of combustion gases.

29. The device of claim 28, wherein the oxidizer is substantially in liquid form.

30. The device of claim 28, wherein the oxidizer is substantially in gaseous form.

31. The device of claim 28, wherein the oxidizer is at thermodynamic equilibrium.

32. The device of claim 28, wherein the oxidizer is not at thermodynamic equilibrium.

33. The device of claim 28, wherein the first container is a composite storage tank.

34. The device of claim 28, wherein the first container is a metal storage tank.

35. The device of claim 28, wherein the oxide of nitrogen is a compound chosen from the group consisting of nitrous oxide, nitric oxide, nitrogen dioxide and dinitrogen tetroxide.

36. The device of claim 28, wherein the outlet comprises a nozzle.

37. The device of claim 36, wherein the device is a rocket device.

38. The device of claim 36, which is an internal combustion engine

39. The device of claim 36, wherein the device additionally comprises:
(a) an air inlet;
(b) an air compressor;
(c) a gas turbine connected with the compressor.

40. The device of claim 39, wherein the device is a jet engine.

41. The device of claim 28, wherein the device is a gas generator.

42. The device of claim 28, wherein the device is a gas turbine.

43. The device of claim 28, further comprising an afterburner.

44. The device of claim 28, wherein the device is substantially self-pressurized.

45. The device of claim 28, wherein the first container additionally comprises O₃.

46. The device of claim 28, wherein the first container additionally comprises a gelling agent.

47. The device of claim 28, wherein the first container additionally comprises an inert gas.

48. A device comprising:
(a) a first container comprising an oxide of nitrogen;
(b) a second container comprising oxygen;
(c) a third container comprising a fuel;
(d) a combustion chamber in fluid or gaseous connection with any or all of the first, second or third containers, wherein the combustion chamber allows the combustion of a propellant comprising a mixture of the oxide of nitrogen, oxygen and fuel to produce combustion gases; and
(d) an outlet allowing the release of combustion gases.

49. The device of claim 48, wherein the oxide of nitrogen is substantially in liquid form.

50. The device of claim 48, wherein the oxygen is substantially in gaseous form.

51. The device of claim 48, wherein the oxide of nitrogen is a compound chosen from the group consisting of nitrous oxide, nitric oxide, nitrogen dioxide and dinitrogen tetroxide.

52. The device of claim 48, wherein the outlet comprises a nozzle.

53. The device of claim 48, wherein the device is a rocket device.

54. The device of claim 48 which is an internal combustion engine.

55. The device of claim 48, wherein the device additionally comprises:
(a) an air inlet;
(b) an air compressor;
(c) a gas turbine connected with the compressor.

56. The device of claim 55, wherein the device is a jet engine.

57. The device of claim 48, wherein the device is a gas turbine.

58. The device of claim 48, wherein the device is a gas generator.

59. The device of claim 48, wherein the device is substantially self-pressurized.

60. The device of claim 48, further comprising an afterburner.

61. A device comprising:
(a) a first container comprising an oxidizer comprising oxygen, wherein the pressure within the container is between about 5 and 200 atm, and wherein the temperature within the container is between −100° C. and 20° C., and further wherein the mass fraction of oxygen within the container is between about 0.02 and 0.5.
(b) a second container comprising a fuel;
(c) a chamber in fluid or gaseous connection with the first container and/or the second container, wherein the combustion chamber allows the combustion of a propellant comprising a mixture of the oxygen and fuel to produce combustion gases; and
(d) an outlet allowing the release of combustion gases.

62. The device of claim 61, wherein the pressure within the first container is between about 5 and 120 atm, and wherein the temperature within the container is between −80° C. and 10° C., and further wherein the mass fraction of oxygen within the container is between about 0.02 and 0.35.

63. The device of claim 61, wherein the first container additionally comprises an oxide of nitrogen.

64. The device of claim 62, wherein the oxide of nitrogen is a compound chosen from the group consisting of nitrous oxide, nitric oxide, nitrogen dioxide and dinitrogen tetroxide.

65. The device of claim 61, wherein the outlet comprises a nozzle.

66. The device of claim 65, wherein the device is a rocket device.

67. The device of claim 65, wherein the device additionally comprises:
(a) an air inlet;
(b) an air compressor;
(c) a gas turbine connected with the compressor.

68. The device of claim 67, wherein the device is a jet engine.

69. The device of claim 61, wherein the device is a gas turbine.

70. The device of claim 61, wherein the device is a gas generator.

71. A rocket device comprising:
a) components for a propellant wherein the components include (i) oxygen and (ii) an oxide of nitrogen;
b) a combustion chamber comprising an outlet;
c) means for feeding the components into the combustion chamber whereby the chamber comprises a propellant; and
d) means to ignite the propellant in the combustion chamber, whereby propellant is combusted and expelled through the outlet.

72. The device of claim 71 wherein the components further comprise (iii) a fuel.

73. The device of claim 72 which is a liquid rocket wherein the motor further comprises:
(i) a first container containing the oxidizer in liquid form;
(ii) a second container containing the fuel; and
(iii) means to mix the oxidizer and the fuel in the combustion chamber to form the propellant.

74. The device of claim 72 which is a solid rocket wherein the motor further comprises a casing that contains the solid phase propellant and the combustion chamber is within the casing.

75. The device of claim 74 wherein the oxidizer is homogenously or heterogeneously mixed with the fuel.

76. The device of claim 72 which is a hybrid rocket wherein the motor further comprises a casing that contains the fuel:
(i) a first container containing the oxidizer in liquid form;
(ii) a casing comprising the fuel and the combustion chamber; and
(iii) means for contacting the oxidizer with the fuel to produce the propellant.

77. The device of claim 76 wherein the fuel comprises a solid oxidizer.

78. The device of claim 77 wherein solid oxidizer is selected from ammonium perchlorate, ammonium nitrate, potassium perchlorate and potassium nitrate.

79. The device of claim 71 wherein the outlet further comprises a nozzle.

80. A method of operating a motor comprising a combustion chamber, the method comprising:
(a) providing an oxidizer comprising an oxide of nitrogen and oxygen;
(b) combusting the oxidizer in a combustion chamber to form a combustion gas; and
(c) expelling the combustion gas from the motor.

81. The method of claim 76, wherein the oxidizer is additionally contacted with a fuel.

82. The method of claim 76, wherein the oxidizer is provided in liquid form.

83. The method of claim 76, wherein the oxidizer is contacted with a fuel prior to combustion.

84. The method of claim 76, wherein thrust is generated during the step of expelling combustion gas.

85. The method of claim 76, wherein the oxidizer has a density greater than about 600 kg/m³, a temperature between about −100° C. and 20° C. and a pressure between about 0 and 200 atm.

86. The method of claim 85, wherein the oxidizer has a density greater than about 800 kg/m³, a temperature between about −80° C. and 10° C. and a pressure between about 5 and 120 atm.
